(19) United States
(12) Patent Application Publication
(10) Pub. No.: US 2020/0227801 A1
(43) Pub. Date: Jul. 16, 2020

(54) ACTIVE RECHARGEABLE BATTERY THERMAL MANAGEMENT SYSTEM

(71) Applicant: SAURAV KUMAR, DELHI (IN)

(72) Inventor: SAURAV KUMAR, DELHI (IN)

(21) Appl. No.: 16/677,654

(22) Filed: Nov. 7, 2019

Related U.S. Application Data
(63) Continuation-in-part of application No. 16/405,169, filed on May 7, 2019, now abandoned.
(60) Provisional application No. 62/667,623, filed on May 7, 2018.

(51) Int. Cl. H01M 10/6572; H01M 10/6556; H01M 10/42; H01M 10/48

(52) U.S. Cl. CPC H01M 10/6572; H01M 10/486; H01M 10/425; H01M 10/6556

(57) ABSTRACT

In one aspect, a thermal management system of rechargeable battery system includes a plurality of rechargeable electrochemical batteries installed in a rechargeable battery pack. The system includes a cooling pump that circulates a liquid coolant mixture through the pipe. The pipe runs through the battery pack and a thermo-electric heater/cooler system, and wherein cooling pump controls a flow speed of the cooling liquid through a pipe that absorbs heat from the plurality of rechargeable electrochemical batteries in each circulation through the pipe. A reservoir holds the liquid coolant mixture and maintains a specified pressure through the pipe. A thermal management system block includes a computing system, computer memory, a computer networking system, and a Pulse-width modulation (PWM) Controller. The PWM Controller is connected with the cooling pump and controls the cooling pump pumping speed to meet the acceptable temperature range in the rechargeable battery pack.

### CROSS-REFERENCE TO RELATED APPLICATIONS

This application is a continuation in part of and claims priority to U.S. patent application Ser. No. 16/405,169, titled ACTIVE RECHARGEABLE BATTERY THERMAL MANAGEMENT SYSTEM and filed on May 7, 2019. This application is hereby incorporated by reference in its entirety. U.S. patent application Ser. No. 16/405,169 claims priority to U.S. provisional patent application No. 62/667,623, titled ACTIVE RECHARGEABLE BATTERY THERMAL MANAGEMENT SYSTEM and filed on May 7, 2018. This application is hereby incorporated by reference in its entirety.

### BACKGROUND

An active battery thermal management system of rechargeable electrical energy storage devices for electrical vehicles without air conditioner or an electric heater to cool or heat the energy storage device.

Performance of a rechargeable electrochemical battery is best around an optimal temperature range (e.g. this range is around 20-40° C., etc.) if the battery chemistry is Lithium Ion. However, if the overall temperature of the electrochemical battery moves outside the range, the battery starts to loose capacity or/and life cycle. This results in less driving per charge and can also impact overall life of the battery pack. In most electric vehicle, an active battery thermal management system uses an air conditioner or an electric heater present onboard the vehicle to decrease or increase overall battery temperature depending on temperature condition of the electrochemical battery. However, there are some segments of automobiles like 3-wheeler or economical 4-wheeler vehicle which are built for lower income group people to earn a livelihood by ferrying people or cargo around. These types are vehicles are extremely popular in developing nations like India, Pakistan, Sri Lanka, Bangladesh, Afghanistan etc. These vehicles doesn't have an external air conditioner or an electric heater. The present disclosure relates to such vehicle where also there is a need to actively thermally manage the rechargeable electrical energy storage devices (e.g., secondary batteries, super or ultra-capacitors) and/or other components (e.g., power converters, control circuits) employed but it can't be done in the current technological fashion because of the dependency on an external air conditioner or an electric heater.

### BRIEF SUMMARY OF THE INVENTION

In one aspect, a thermal management system of rechargeable battery system includes a plurality of rechargeable electrochemical batteries installed in a rechargeable battery pack. The system includes a cooling pump that circulates a liquid coolant mixture through the pipe. The pipe runs through the battery pack and a thermo-electric heater/cooler system, and wherein cooling pump controls a flow speed of the cooling liquid through a pipe that absorbs heat from the plurality of rechargeable electrochemical batteries in each circulation through the pipe. A reservoir holds the liquid coolant mixture and maintains a specified pressure through the pipe. A thermal management system block includes a computing system, computer memory, a computer networking system, and a Pulse-width modulation (PWM) Controller. The PWM Controller is connected with the cooling pump and controls the cooling pump pumping speed to meet the acceptable temperature range in the rechargeable battery pack.

### BRIEF DESCRIPTION OF THE DRAWINGS

FIG. 1 illustrates an example thermal management system of rechargeable battery, according to some embodiments.

FIG. 2 illustrates an example Thermal Management System (TMS) input and output process, according to some embodiments.

FIGS. 3-5 illustrate an example view of a Thermo-Electric System, according to some embodiments.

FIG. 6 illustrate an example of conductor block made out of aluminum or similar thermal conducting material to hold the cylindrical cells, according to some embodiments.

FIG. 7 illustrate an example rechargeable battery module where six (6) cylindrical Li ion cells are connected in parallel with conductor block in between, according to some embodiments.

FIG. 8 illustrates an example cooling tube in contact with the multiple rechargeable battery module containing the conductor block, according to some embodiments.

FIG. 9 illustrate an example coolant channel comprising of multiple cooling tubes, according to some embodiments.

The Figures described above are a representative set and are not an exhaustive with respect to embodying the invention.

### DESCRIPTION

Disclosed are a system, method, and article of manufacture for active rechargeable battery thermal management system. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment’; ‘an embodiment,’ ‘one example,’ or similar language means that a particular feature, structure, or characteristic described in connection with the embodiment is included in at least one embodiment of the present invention. Thus, appearances of the phrases ‘in one embodiment’; ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Heat sink a passive heat exchanger that transfers the heat generated by an electronic or a mechanical device to a fluid medium, often air or a liquid coolant, where it is dissipated away from the device, thereby allowing regulation of the device's temperature at optimal levels.

Peltier effect is the presence of heating or cooling at an electrified junction of two different conductors. The Peltier effect is known to have low heating/cooling effect with respect to power applied. The effectiveness of a heating/cooling system can be increased in several ways, such as: cascading the Peltier material; increasing the surface area which interacts with the coolant than just the surface. This can be done by increasing the size of fins that are connected with Peltier material.

Proportional-integral-derivative controller (PID controller) is a control loop feedback mechanism widely used in industrial control systems and a variety of other applications requiring continuously modulated control. A PID controller continuously calculates an error value as the difference between a desired setpoint (SP) and a measured process variable (PV) and applies a correction based on proportional, integral, and derivative terms (denoted P, I, and D respectively) which give the controller its name.

Pulse-width modulation (PWM) is a modulation technique used to encode a message into a pulsing signal.

System on a chip or system on chip (SoC) is an integrated circuit (also known as a “chip”) that integrates all components of a computer or other electronic system. These components typically (but not always) include a central processing unit (CPU), memory, input/output ports and/or secondary storage.

### EXAMPLE EMBODIMENTS

Present systems include a liquid-controlled system that includes a coolant fluid such as liquid glycol. The coolant flows through an electrical-energy storage device in a pipe comprised of a thermally conducting material (e.g. aluminum or copper), in contact with the electrical-energy storage device. The coolant in the pipe then absorbs the excess heat in case the storage device's temperature is above the coolant's temperature. A pump is fitted with this pipe and moves the coolant through the pipe to the vehicle's air conditioner unit. In an air-controlled system, air passes through the electrical energy storage devices. To heat the electrical pack when the temperature falls below a specified threshold, the air is pre-heated using an electrical heater. Conversely, on hot days, the air is cooled using an external coolant tube and this cool air when passes over the storage unit reducing the temperature.

Present systems use the Peltier effect to achieve both heating and cooling of the electrical sub-system. Due to the thermo-electric effect, a Peltier material can heat up one side and cool another side depending on the flow of the current of the coolant or air.

In one example, a separate sub-module (e.g. see infra) can control the temperature of the liquid coolant or air based on a preset requirement/specification. The sub-module can force the coolant/air through a thermally conducting tube. The thermally conducting tube is connected with a thermo-electric/Peltier material along its sides. A thermal conducting glue can be applied between the material and the pipes through which the liquid coolant flows. Depending on requirement to cool or heat the coolant, current polarity along the Peltier material's terminals are reversed. As the coolant passes near the thermos-electric material, the coolant's temperature increases or reduced depending on the desired state. A motor along the pipe(s) pushes the coolant at a controlled speed.

It is noted that this system has multiple advantages, such as, inter alia: simple component is used to provide both cooling and heating; reduced need to maintain the system over a period of time as the number of component involved are really less.

Example Systems

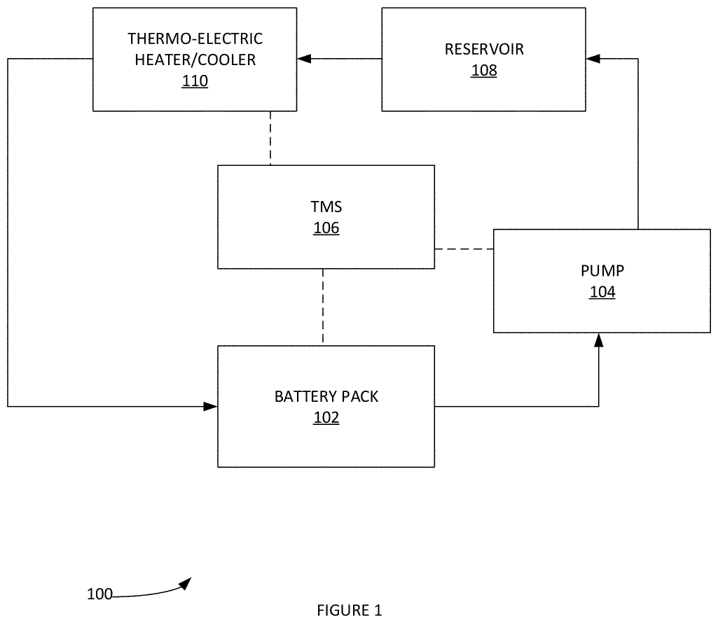

FIG. 1 illustrates an example thermal management system 100 of rechargeable battery, according to some embodiments. Thermal management system 100 includes various subsystems as now discussed. Subsystems can be coupled with a pipe/tube through which glycol and/or other liquid coolant circulates. Other subsystems can be control/sensor subsystems that are communicatively coupled (e.g. wirelessly/electrically coupled, etc.) with the wiring harness.

Thermal management system 100 includes a thermo-electric heater/cooler system 110, according to some embodiments. Thermo-electric heater/cooler system 110 can maintain the temperature of the rechargeable battery pack within a specified range (e.g. 20-35° C. centigrade) of an operating temperature. Rechargeable battery pack can include a rechargeable electrochemical battery 102. Thermo-electric heater/cooler system 110 can implement a thermoelectric/Peltier effect-based heating/cooling is shown. Thermo-electric heater/cooler system 110 includes an ‘in’ and ‘out’ for liquid coolant to enter at elevated temperature and leave with reduced temperature. Inside the thermo-electric cooler, the pipe runs through aluminum or similar thermally conducting material block which is sandwiched with thermo electric material on either side. Thermo-electric heater/cooler system is connected with battery pack, pump and reservoir through the thermally insulating pipe.

The cooling pump 104 circulates the glycol or other liquid coolant mixture through the pipe which runs through the battery pack and the thermo-electric heater/cooler system 110. Pump 104 controls the speed of the cooling liquid through the pipes. The speed of the pump 104 is controlled via a PWM controller that is internally connected with the thermal management system block 106. A high PWM value sets the pump in a faster mode. For example, the pump moves higher volume of coolant through the pipe, absorbing more heat in each circulation through the pipe. Reservoir 108 hold liquid coolant and help maintain required pressure through the pipe.

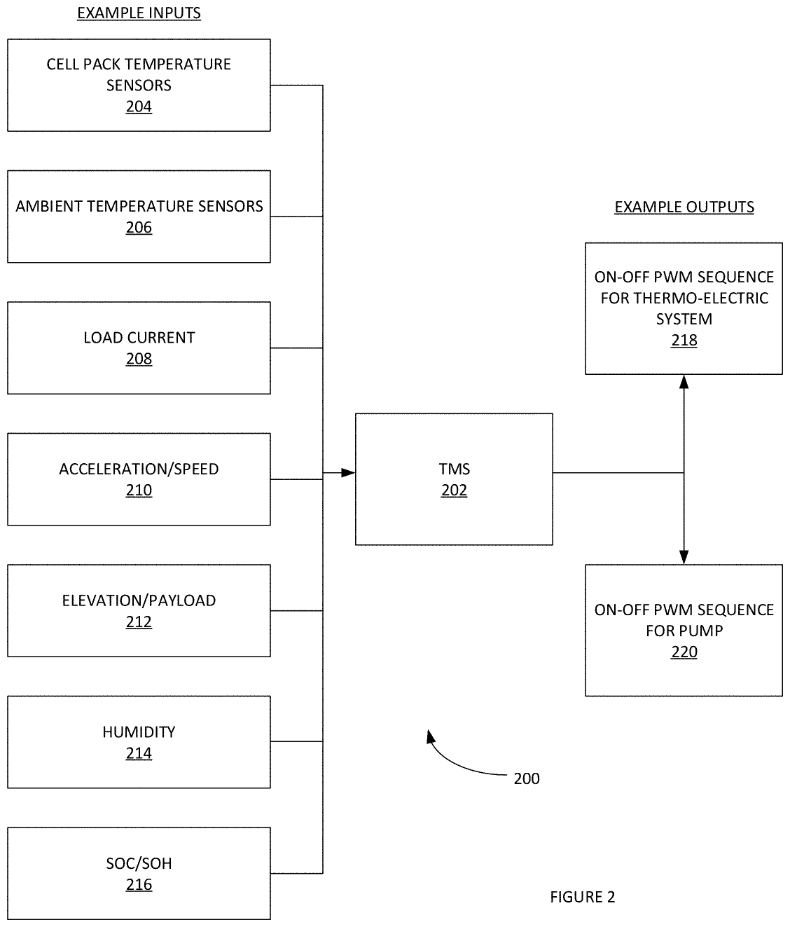

Thermal management system 100 includes a series of internal temperature sensors. Multiple temperature sensors are placed inside the battery pack to measure the temperature of the battery cell blocks. Various example sensor systems are discussed in FIG. 2 infra. The temperature sensors are positioned to improve measurement and increase redundancy. In one example, six to eight temperature sensors can be connected along the packs to measure battery cell temperatures of a battery pack. Temperature sensors are placed at the points of input and output of the liquid coolant in the battery packs. The temperature sensors can be directly glued to the battery cell or conductor block. In another example, the temperature sensors can be connected to larger copper/nickel bus bars.

Thermal management system 100 can use a series of external temperature sensors. The external temperature sensors can measure temperatures outside the battery pack. Data from these external temperature sensors and internally temperature sensors are used to signal the thermal management system more frequently to measure all temperature data across the rechargeable battery pack (e.g. in the case where external temperatures are above a specified threshold, the vehicle is running, etc.).

Thermal management system 100 can include a Thermal Management System (TMS) 106. TMS 106 can include a computing system, computer memory, networking systems, etc. TMS 106 can include a PWM Controller. The PWM Controller is connected with a pump 104. Depending upon how aggressively or slowly thermal management system 100 is set to meet the acceptable temperature range in the rechargeable battery pack, it sets the PWM control to a high setting or to a low setting.

Thermal management system 100 can include a feedback controller. For example, a PID control block monitors the required thermal conditions the system is set to achieve. The PID control block monitors the current thermal conditions and control parameters (e.g. PWM, Polarity Switch etc.). Depending current state and required states, the PID control block predicts and sets the value of the control parameters. After a set delta time, the PID control block aggregates feedback and update the control parameters. This process repeats until the battery pack reaches the optimal temperature. A polarity reverser block can consist of couple of relays system with control signal switch. The polarity reverser block switches polarity of input terminal for the thermoelectric material.

FIG. 2 illustrates an example Thermal Management System (TMS) input and output process 200, according to some embodiments. Process 200 can utilize various sensors and/or other inputs 204-216. These include, inter alia: cell pack temperature sensors 204, ambient temperature sensors 206, load current sensor 208, acceleration/speed sensor 210, elevation/payload sensor 212, humidity sensor 214, SOC/SOH 216, etc. Cell pack temperature sensors 204 can sense and provide the temperatures cell pack(s). Ambient temperature sensors 206 can sense and provide the ambient temperature to the TMS. Load current sensor 208 can provide a value of the load current drawn from the battery pack and/or subunits of the battery pack. Acceleration/speed sensor 210 can provide a current acceleration value and speed value of the system where battery pack is placed. Elevation/payload sensors 212 can obtain and provide various elevation and payload condition to predetermine the future current responses. Humidity sensor 214 can provide the current humidity of the system. This helps to determine the dew points so that the temperature is maintained in order to avoid conditions of water droplets on the battery pack. SOC/SOH 216 mentions state of charge/state of health of the battery packs. These inputs are provided by way of example and not of limitation.

TMS 202 manages the various subsystems of the rechargeable battery based on the input values and/or other parameters. TMS 202 calculate outputs based on the inputs. TMS 202 obtains the inputs of various sensors and/or other inputs 204-216. TMS 202 can provide output signals to various subsystems. For example, TMS 202 can generate a control signal for the on-off PWM sequence for thermo-electric system 218. TMS 202 can generate a control signal for the on-off PWM sequence for pump 220. These outputs are provided by way of example and not of limitation. TMS 202 utilize various optimization algorithms to determine an optimal range of liquid coolant speed, liquid coolant temperature, etc. These optimization algorithms can utilize the data provided by inputs 204-216.

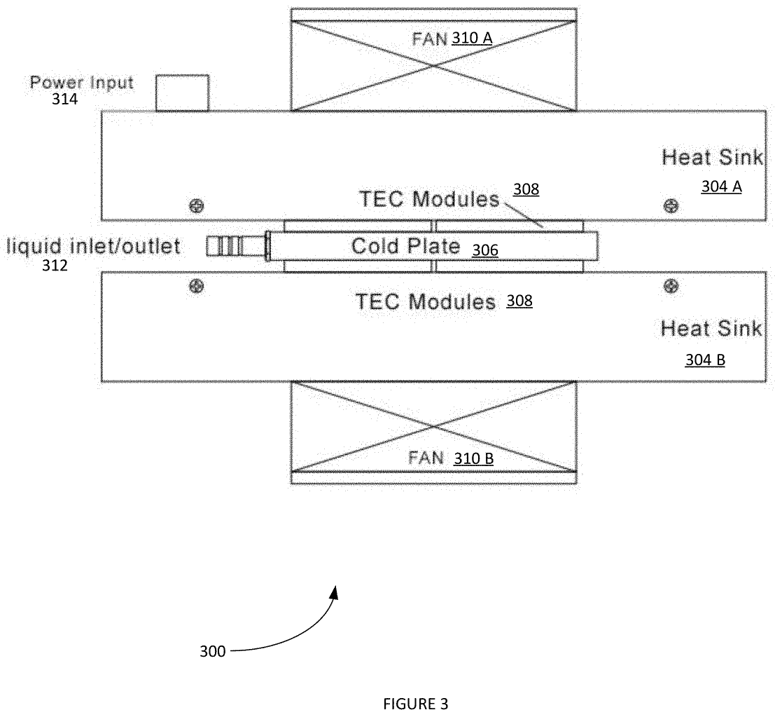

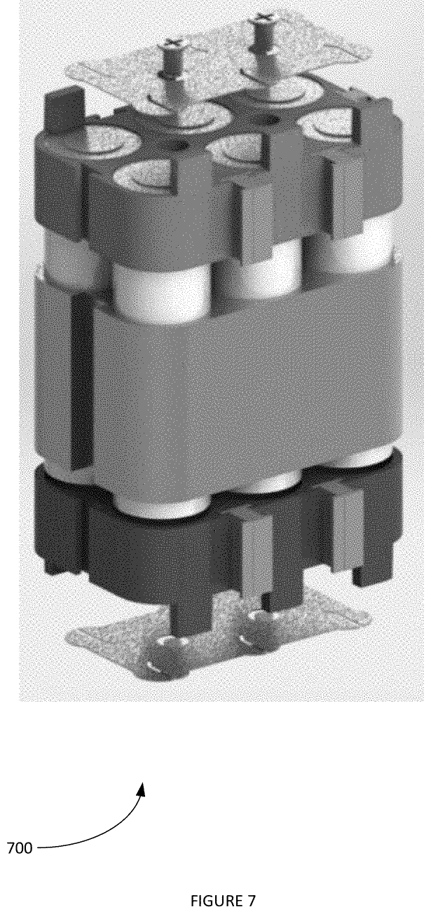

FIGS. 3-5 illustrate an example view of a Thermo-Electric System 300-500, according to some embodiments. More specifically, FIG. 3 illustrates an example side view of Thermo-Electric System 300, according to some embodiments. Thermo-Electric system 300 includes a conductor block. Thermo-Electric System 300 includes one or more thermoelectric cooler (TEC) module(s) 308. A TEC module 308 can use the Peltier effect to create a heat flux at the junction of two different types of materials. TEC module 308 can include a solid-state active heat pump which transfers heat from one side of the device to the other, with consumption of electrical energy, depending on the direction of the current. Cooling plate(s) 306 absorb heat which is then moved to the other side of the Thermo-Electric System 300 where the heat sink(s) 304 A-B are located. Heat sink(s) and fans 304 A-B are used to keep the heated part of the TEC modules at the ambient temperature to improve efficiency of the Thermo-Electric System. Liquid inlet(s)/outlet(s) 312 can supply the liquid to be cooled. Power input 314 can be coupled with a power source and provide the needed power to operate Thermo-Electric System 300. Thermo-Electric System 300 utilizes the Peltier effect to cool the input liquid coolant. Heat sink(s) 304 A-B are used to remove excess heat generated in the process. It is noted that TEC modules can be combined in series and/or parallel (e.g. see FIG. 7 infra). Cascading the TEC modules can improve the heat transfer and cooling dynamics of the system. The ambient temperature of the Thermo-Electric System 300 is measured as well.

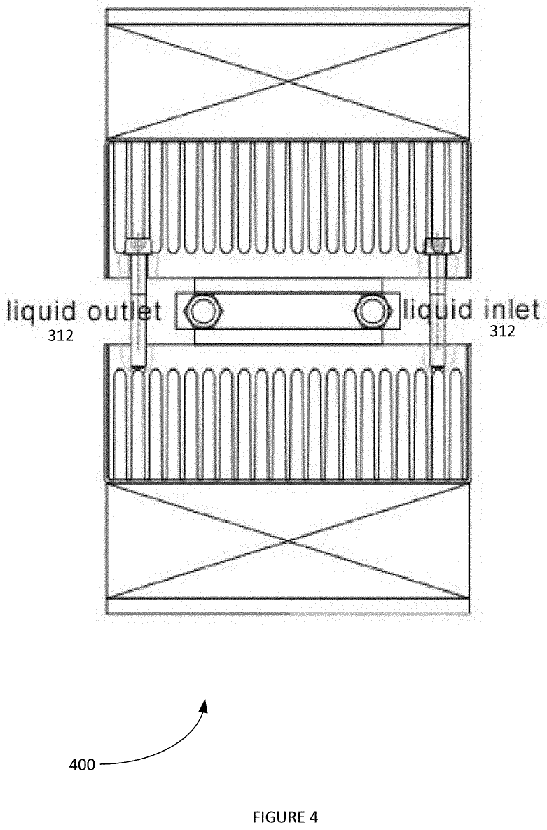

FIG. 4 illustrates a conductor block's top and perspective view 400 of the Thermo-Electric system 300, according to some embodiments. View 400 illustrates the location of liquid inlet(s)/outlet(s) 312.

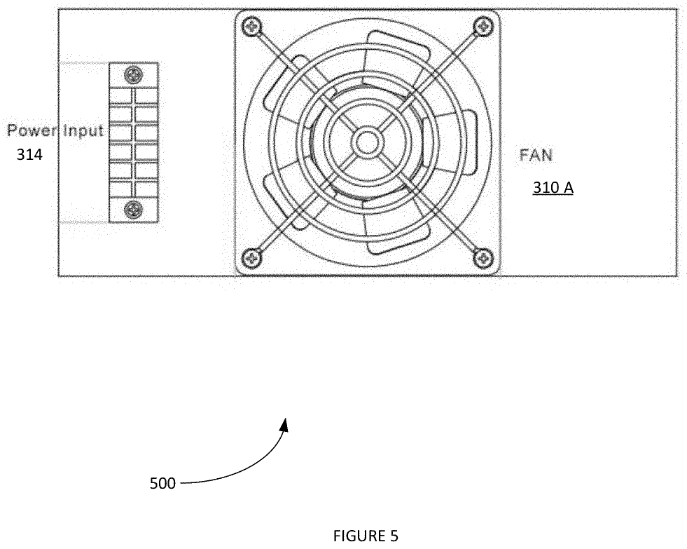

FIG. 5 illustrates an example view 500 of Thermo-Electric system 300, according to some embodiments. View 500 illustrates the location of power input 314 and fan 310 A.

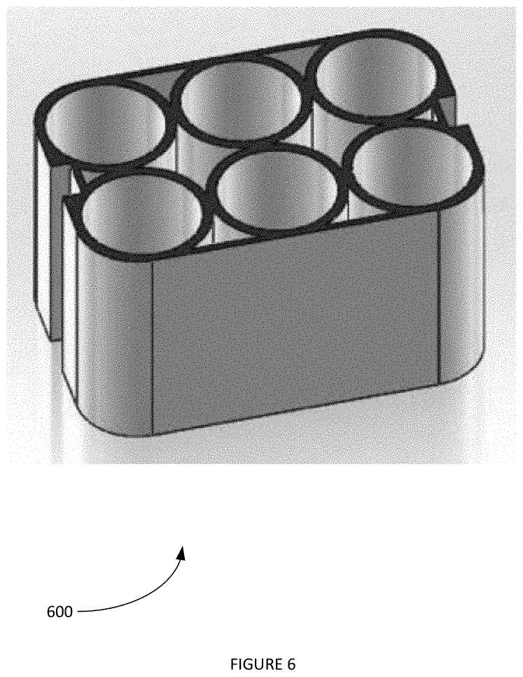

FIG. 6 illustrate an example of conductor block made out of aluminum or similar thermal conducting material to hold the cylindrical cells, according to some embodiments. Conductor block heats up as the cell temperature increases. Amount of heat transfer can be controlled by the height of the conductor block. The height of the conductor blocks can be set to seventy-five percent (75%) of the height of the battery cell.

FIG. 7 illustrate an example rechargeable battery module where six (6) cylindrical Li ion cells are connected in parallel with conductor block in between, according to some embodiments. These cell modules are arranged in series and parallel to achieve a specified voltage and capacity, according to some embodiments. In the sample, the Lithium ion cells can be spot welded in parallel using Nickel strips and/or screwed together to create modules and then these modules are connected in series with each other using copper nickel strips

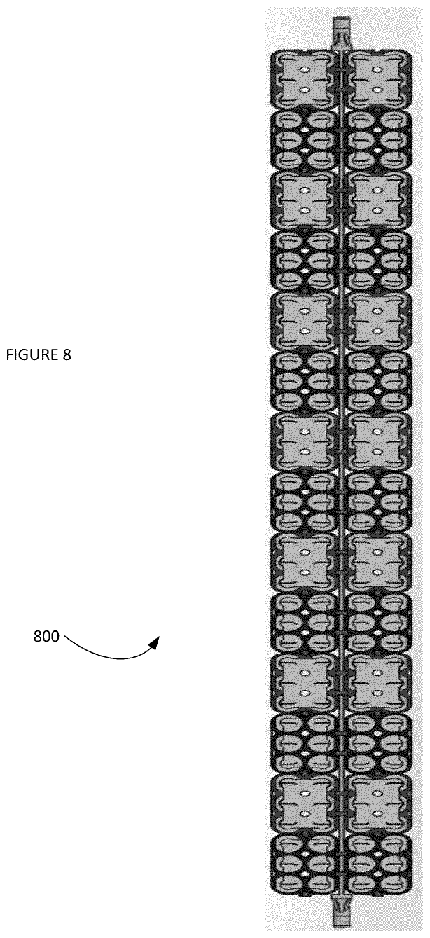

FIG. 8 illustrates an example cooling tube in contact with the multiple rechargeable battery module containing the conductor block, according to some embodiments. The cooling liquid in the pipe can cool the conductor block. A thermal paste and/or another thermal conducting material can be used to ensure that the touch points between the pipe and conductor block are conductive.

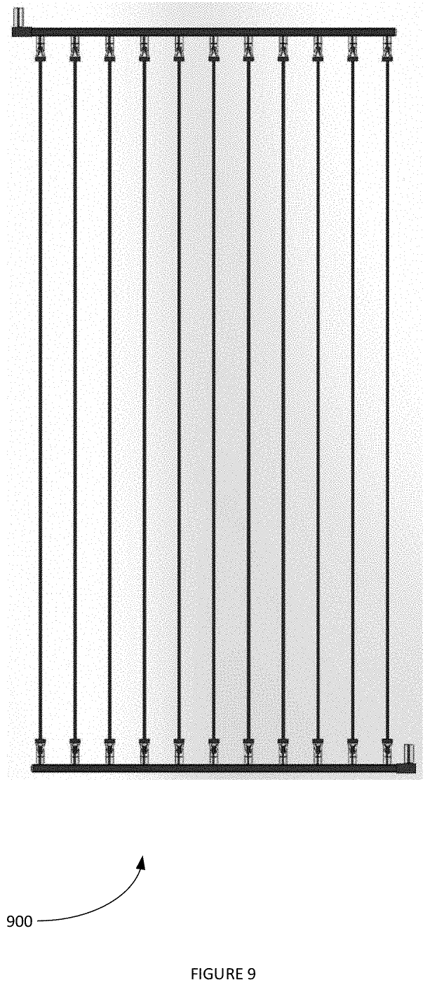

FIG. 9 illustrate an example coolant channel comprising of multiple cooling tubes, according to some embodiments. The liquid coolant can pass through the channels and cool the touching portions of the rechargeable battery module. The holes are size such there is a tight fit and the heat transfer is proportional to the amount of surface area that is in contact with the touching portions of conductor block of the rechargeable battery module.

### ADDITIONAL EXAMPLE EMBODIMENTS

In one embodiment, the system can use the Peltier effect through thermoelectric system to cool or heat the battery pack in the case where HVAC is either not available or not recommended (e.g. an air-conditioner/heater or external is absent, etc.). These can exist in various scenarios such as, inter alia, the following. In small/light electric vehicles not limited to small 2 W, 3 W, light 4 W, aerial vehicles, underwater vehicles, surface vehicles, robots, etc. Energy storage system for applications not limited to micro-grid, inverters, base tower stations in conditions which are extremely unfavorable for li-ion battery operating temperature. The system can improve the efficiency of the thermoelectric system to improve its efficiency using.

The system can keep one of the end of the thermo-electric plate at the ambient temperature to have increased better efficiency. The system can use a heat sink of the thermo-electric plate that increases the surface area to further increase the heat transfer rate between the Thermoelectric the material's one of the side and ambient air. The system can use cascaded thermoelectric material to achieve a faster heat transfer rate. Cascading can be achieved through series, two material on top of each other connected through thermal conducting material with extremely high thermal conductivity.

The system can be used to facilitate heat transfer between the heat generated between the Li-ion cell and the liquid following in cooling pipe, a conductor block has been designed which: touches the li-ion cells from the entire 360 degrees thereby greatly increasing the surface area for heat transfer; certain section of the conductor block can be extruded to reduce the weight of the block without impacting heat transfer rate but greatly reducing the weight of the entire battery pack; height of the conductor block can be varied to match the height of the cooling tubes and desired heat transfer rate; and/or for conducting block further adds to mechanical rigidity of the module structure allowing the battery pack to be more resistant to force/impact.

The system can include a design of coolant channel which is comprised of multiple cooling tubes with a manifold with one or multiple inlets and one or multiple outlets in a way that each the cooling tube is a linear extruded aluminum section with no bending allowing for maximum surface contact between conductor block and the cooling tube. The cooling tube is sandwiched between the battery pack module in either side. Each cooling tube receives liquid coolant at the same inlet temperature and volumetric speed allowing even cooling of cells across the entire battery pack.

The system can use a computer algorithm that controls the speed of the water pump, switching off the thermo-electric system using data not limited from temperature sensors placed on the inlet and outlet of the cooling manifold, across different areas of the battery pack, ambient temperature outside battery pack, currently requested, humidity, the elevation of road, acceleration, speed. The computer algorithm inside the thermal management system can use a machine learning algorithm to achieve required temperature and maintaining within the range of 20-30 degrees.

The system can be used to achieve cooling while fast charging of battery pack is happening where the cooling system is not taking energy from the being charged battery pack. Instead, the external power system uses grid power for charging the battery and simultaneously powering the external thermoelectric cooler. In this way, the system allows us to fast charge the battery pack without putting the temperature of the battery pack outside the battery range.

### CONCLUSION

Although the present embodiments have been described with reference to specific example embodiments, various modifications and changes can be made to these embodiments without departing from the broader spirit and scope of the various embodiments.

What is claimed as new and desired to be protected by Letters Patent of the United States is:

1. A thermal management system of rechargeable battery system comprising:
a plurality of rechargeable electrochemical batteries installed in a rechargeable battery pack;
a thermo-electric system comprising one or more thermoelectric cooler (TEC) modules that comprises a Peltier element configured to use the Peltier effect to cool the liquid coolant;
a cooling pump that circulates a liquid coolant mixture through the pipe, wherein the pipe runs through the battery pack and a thermo-electric heater/cooler system, and wherein cooling pump controls a flow speed of the cooling liquid through a pipe that absorbs heat from the plurality of rechargeable electrochemical batteries in each circulation through the pipe;
a reservoir that holds the liquid coolant mixture and maintains a specified pressure through the pipe; and
a thermal management system block comprising a computing system, computer memory, a computer networking system, and a Pulse-width modulation (PWM) Controller, wherein the PWM Controller is connected with the cooling pump and controls the cooling pump pumping speed to meet the acceptable temperature range in the rechargeable battery pack.

2. The thermal management system of claim 1, wherein a set of subsystems are coupled with the pipe, where the set of subsystems comprise a control subsystem and a sensor subsystem that are communicatively coupled with a wiring harness of the thermal management system.

3. The thermal management system of claim 1, wherein the liquid coolant mixture comprises glycol.

4. The thermal management system of claim 3, wherein the speed of the cooling pump 104 is controlled via a PWM controller that is internally connected with the thermal management system block.

5. The thermal management system of claim 4, wherein a high PWM value sets the pump in a faster mode.

6. The thermal management system of claim 5, wherein the cooling pump moves a higher volume of coolant through the pipe.

7. The thermal management system of claim 6, wherein a series of internal temperature sensors that placed inside the battery pack to measure the temperature of the battery cell blocks.

8. The thermal management system of claim 1, wherein the PWM control is set to a high PWM setting or to a low PWM setting.

9. The thermal management system of claim 8, wherein the high PWM value sets the pump in a faster mode, and wherein the pump moves a higher volume of liquid coolant through the pipe, absorbing more heat in each circulation through the pipe.

10. The thermal management system of claim 9, wherein the temperature sensors are placed at the points of input and output of the liquid coolant in the rechargeable battery pack.

11. The thermal management system of claim 10, wherein temperature sensors are directly glued to a battery cell of the plurality of rechargeable electrochemical batteries or a conductor block.

12. The thermal management system of claim 11 further comprising:
a feedback controller, wherein the feedback controller comprises a Proportional-integral-derivative controller (PID controller) that monitors the thermal conditions the thermal management system.

13. The thermal management system of claim 12, wherein the PID control block monitors a set of current thermal conditions and control parameters.

14. The thermal management system of claim 13, wherein the set of current thermal conditions and control parameters a PWM value and a Polarity Switch value.

15. The thermal management system of claim 14, wherein the PID control block predicts and sets the value of the control parameters by, after a set delta time, aggregating a set of feedback and update the control parameters.

16. The thermal management system of claim 15, wherein the PID control block repeats the aggregating a set of feedback and update the control parameters until the rechargeable battery pack reaches a specified temperature.

17. The thermal management system of claim 16 further comprising:
a polarity reverser block comprising a relay system with a control signal switch.

18. The thermal management system of claim 17, wherein the polarity reverser block switches a polarity of an input terminal for the thermoelectric material.

19. The thermal management system of claim 1, wherein the comprises sub-module that force the liquid coolant through a thermally conducting tube connected with Peltier material along its sides.

20. The thermal management system of claim 19, wherein a thermal conducting glue is applied between the Peltier material and the cooling pips through which the liquid coolant flows.
